(19) United States
(12) Patent Application Publication
(10) Pub. No.: US 2012/0048295 A1
(43) Pub. Date: Mar. 1, 2012

(54) CLEANING FORMULATION FOR REMOVING RESIDUES ON SURFACES

(75) Inventors: Bing Du, Gilbert, AZ (US); William A. Wojtczak, Austin, TX (US); Stanley A. Ficner, Mesa, AZ (US)

(73) Assignee: FUJIFILM ELECTRONIC MATERIALS U.S.A., INC., North Kingstown, RI (US)

(21) Appl. No.: 13/254,944

(22) PCT Filed: Mar. 9, 2010
(86) PCT No.: PCT/US10/26601

§ 371 Date: Nov. 10, 2011

Related U.S. Application Data
(60) Provisional application No. 61/159,200, filed on Mar. 11, 2009.

(51) Int. Cl. C23G 1/02; C11D 7/60

(52) U.S. Cl. 134/3; 510/175

(57) ABSTRACT

This disclosure relates to compositions that can be used to remove residues from a semiconductor substrate.

### CROSS-REFERENCE TO RELATED APPLICATION

This application claims priority from U.S. Provisional Patent Application No. 61/159,200 filed Mar. 11, 2009, the entire contents of which are incorporated herein by references.

### BACKGROUND

1. Field of the Disclosure

The present disclosure relates to a novel cleaning composition for semiconductor substrates and a method of cleaning semiconductor substrates. More particularly, the present disclosure relates to a cleaning composition for removing plasma etch residues formed on semiconductor substrates after plasma etching of metal layers or dielectric material layers deposited or grown on the substrates and the removal of residues left on the substrates after bulk resist removal via a plasma ashing or wet stripping process.

2. Discussion of the Background Art

In the manufacture of integrated circuit devices, photoresists are used as an intermediate mask for transferring the original mask pattern of a reticle onto the wafer substrate by means of a series of photolithography and plasma etching steps. One of the essential steps in the integrated circuit device manufacturing process is the removal of the patterned photoresist films from the wafer substrate. In general, this step is carried out by one of two methods.

One method involves a wet stripping step in which the photoresist-covered substrate is brought into contact with a photoresist stripper solution that consists primarily of an organic solvent and an amine. However, stripper solutions cannot completely and reliably remove the photoresist films, especially if the photoresist films have been exposed to UV radiation and plasma treatments during fabrication. Some photoresist films become highly crosslinked by such treatments and are more difficult to dissolve in the stripper solution. In addition, the chemicals used in these conventional wet-stripping methods are sometimes ineffective for removing inorganic or organometallic residual materials formed during the plasma etching of metal or oxide layers with halogen-containing gases.

An alternative method of removing a photoresist film involves exposing a photoresist-coated wafer to oxygen-based plasma in order to burn the resist film from the substrate in a process known as plasma ashing. However, plasma ashing is also not fully effective in removing the plasma etching by-products noted above. Instead removal of these plasma etch by-products must be accomplished by subsequently exposing the processed metal and dielectric thin films to certain cleaning solutions.

Metal substrates are generally susceptible to corrosion. For example, substrates such as aluminum, copper, aluminum-copper alloy, tungsten nitride, and other metals and metal nitrides will readily corrode by using conventional cleaning chemistries. In addition the amount of corrosion tolerated by the integrated circuit device manufacturers is getting smaller and smaller as the device geometries shrink.

At the same time as residues become harder to remove and corrosion must be controlled to ever lower levels, cleaning solutions must be safe to use and environmentally friendly.

Therefore, the cleaning solution must be effective for removing the plasma etch and plasma ash residues and must also be non-corrosive to all exposed substrate materials. The ability to clean the broad range of residues encountered, and be non-corrosive to exposed substrate materials is achieved by using the cleaning composition of the present disclosure.

### SUMMARY OF THE DISCLOSURE

The present disclosure is directed to a non-corrosive cleaning composition that is useful primarily for removing residues (e.g., plasma etch and/or plasma ashing residues) from a semiconductor substrate as an intermediate step in a multistep manufacturing process. These residues include a range of relatively insoluble mixtures of organic compounds like residual photoresist, organometallic compounds, metal oxides which are formed as reaction by-products from exposed metals such as aluminum, aluminum/copper alloy, copper, titanium, tantalum, tungsten, cobalt, metal nitrides such as titanium and tungsten nitride, and other materials.

The cleaning composition of this disclosure includes: (a) at least one alpha amino carboxylic acid containing at least one additional functional group capable of chelating metals with the proviso that the alpha amino carboxylic acid does not contain an additional carboxyl group; (b) at least one hydroxycarboxylic acid containing at least two carboxyl groups and at least one hydroxyl group; (c) optionally, at least one hydrazinocarboxylic acid ester; (d) at least one alkanolamine, and (e) water; with the provisos that the at least one hydroxycarboxylic acid does not contain an amino group alpha to a carboxylic acid group, and that the pH of the composition is between about 6 and about 10. Surfactants, organic solvents (e.g., water miscible organic solvents), and other additives may also be optionally employed in the aqueous cleaning compositions. Preferably, that the composition is free of components containing fluorides, abrasives and oxidizers. Without wishing to be bound by theory, it is believed that the cleaning composition of the present disclosure effectively cleans a semiconductor substrate and minimizes corrosion of metals contained thereon in a basic aqueous environment because metal corrosion is greatly inhibited with the use of a combination of water soluble organic compounds. The higher pH (e.g., from about 6 to about 10) of the cleaning composition acts to enhance its residue cleaning performance.

Other embodiments of this disclosure include post etch and/or post ash residue removal methods described below.

### DETAILED DESCRIPTION OF THE DISCLOSURE

As defined herein unless otherwise noted, all percentages expressed should be understood to be percentages by weight to the total weight of the cleaning composition. An organic solvent in the context of this disclosure is defined as a carbon-containing material that is miscible with water and does not react with any of the components of the cleaning composition at ambient temperature. Unless otherwise noted, ambient temperature is defined to be between about 16 and about 27 degrees Celsius (° C.).

The present disclosure is directed to aqueous non-corrosive cleaning compositions that are useful primarily for removing plasma etch residues from a semiconductor substrate as an intermediate step in a multistep manufacturing process. These residues consist of a range of relatively insoluble mixtures of organic compounds like residual photoresist, organometallic compounds, metal oxides which are formed as reaction by-products from exposed metals such as aluminum, copper, aluminum-copper alloys, titanium tantalum, tungsten, metal nitrides such as titanium and tungsten nitride, and other materials.

In designing the cleaning composition tradeoffs between cleaning efficiency and metal compatibility are frequently being made. Metal corrosion can be reduced by incorporating chelators in the cleaning composition if the chelator is appropriately matched with the metal. Chelating agents are compounds that can form more than one coordinate bond to a single metal ion. The metal cation is called the central atom, and the anions or molecules with which it forms a coordination compound or complex are referred to as ligands. If a ligand is composed of several atoms, the one responsible for the basic or nucleophilic nature of the ligand is called the ligand atom. A compound that contains more than one ligand atom is said to be a multidentate chelator. Generally, the effectiveness of a chelator increases with the number of coordinating bonds it can support. Compounds containing groups such as hydroxyl, amino, guanido (also sometimes referred to as guanidine), imidazolyl, hydrazino, amido, nitrilo, thio, carboxyl and carbonyl groups can have metal chelating properties.

This disclosure describes combinations of alpha amino carboxylic acids having specific structural characteristics and certain hydroxycarboxylic acids resulting in surprisingly superior corrosion inhibition towards aluminum and other metals when used in cleaning compositions. This combination of alpha amino acids and hydroxycarboxylic acids of the present disclosure provides superior cleaning, increases corrosion resistance via formation of organometallic chelated species on clean exposed metal surfaces and provides chelation and capture capability of unwanted trace metal contaminates that otherwise redeposit back onto the surface of the semiconductor substrate in a pH range sufficiently high to facilitate the residue removal from the substrate.

The cleaning composition includes: (a) at least one alpha amino carboxylic acid containing at least one additional functional group capable of chelating metals with the proviso that the at least one alpha amino carboxylic acid does not contain an additional carboxyl group; (b) at least one hydroxycarboxylic acid containing at least two carboxyl groups and at least one hydroxyl group; (c) at least one hydrazinocarboxylic acid ester; (d) at least one alkanolamine, and (e) water; with the provisos that the hydroxycarboxylic acid does not contain an amino group alpha to a carboxylic acid group. The pH of the composition is between about 6 and about 10. Surfactants, organic solvents, and other additives may also be optionally employed in the aqueous cleaning compositions. Preferably, the composition is free of components containing fluorides, abrasives and oxidizers.

It is understood to those skilled in the art that upon mixing components (a) to (e) of the cleaning composition acid-base reactions may take place resulting in the formation of salts in the cleaning composition.

One of the key components in the cleaning composition of the present disclosure is the alpha amino carboxylic acid. In combination with the hydroxycarboxylic acid the alpha amino carboxylic acid provides enhanced metals corrosion protection to the semiconductor substrates being cleaned.

In general, the alpha amino carboxylic acids suitable for the cleaning composition of the present disclosure includes at least one additional functional group capable of chelating metals (other than a carboxyl group). Examples of such function groups include hydroxyl, amino, guanido, imidazolyl, hydrazino, amido, nitrilo, thio, and carbonyl groups. Examples of alpha amino carboxylic acids of this disclosure include, but are not limited to, tricine, bicine, creatine, guanidineacetic acid, threonine, 3-hydroxynorvaline, 4-hydroxy-L-proline, L-alpha-(2-(2-aminoethoxy)vinyl)glycine, N-(2-mercaptopropionyl)glycine, N-(4-hydroxyphenyl)glycine, tyrosine, meta-tyrosine, 3-nitrilo-tyrosine, 3-iodo-tyrosine, Dopa(DL-threo-3,4-Dihydroxyphenylaniline), 3-(2,4,5-trihydroxyphenyl)alanine, 3,5-amino-L-tyrosine, 4-amino-phenylalanine, 4-nitro-phenylalanine, 3,5-dinitro-L-tyrosine, alpha-methyltyrosine, 3-(3,4-dihydroxyphenyl)-2-methyl alanine, threo-3-phenylserine, DL-threo-3,4-dihydroxyphenylserine, carbobenzyloxy serine, N-2-(carbobenzyloxy)lysine, carbobenzyloxy asparagine, carbobenzyloxy glutamine, 5-aminoorotic acid, 3-amino-1H-1,2,4-triazole-5-carboxylic acid, pyrrolysine, and compounds of Structure (1):

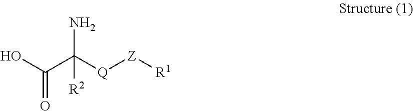

wherein Q is an unsubstituted branched or linear C₁-C₅ alkylene, or ˜CH₂—(CH₂)ₙ—O˜; in which n is an integer from 0 to 5; Z is ˜NR³˜ or a divalent bond; R³ is a hydrogen atom or a C₁-C₄ alkyl group; R¹ is an imidazolyl, H₂N—C(═NR⁴)˜, NH₂NH—C(═NR⁵)˜, amino, amido, hydrazino, hydroxyl or thiol group, or a C₁-C₅ alkyl group substituted with at least one functional group selected from the group consisting of imidazolyl, guanido, amino, amido, hydrazino, hydroxyl or thiol group, in which R⁴ and R⁵ are independently a hydrogen atom or a C₁-C₄ alkyl group; and R² is a hydrogen atom or a C₁-C₄ alkyl group.

Examples of alpha amino carboxylic acids of Structure (1) include, but are not limited to, arginine, histidine, canavanine, 2,3-diaminopropionic acid, serine, homoserine, 5-hydroxylysine, mimosine, 2,4-diaminobutyric acid, ornithine, 2-methylornithine, lysine, N-ε-methyllysine, asparagine, cysteine, penicillamine, homocysteine, methionine, ethionine, S-benzyl-L-cysteine and S-trityl-L-cysteine.

Preferred alpha amino carboxylic acids of this disclosure include, but are not limited to, tricine, creatine, guanidineacetic acid, and compounds of Structure (1).

More preferred alpha amino carboxylic acids of this disclosure include, but are not limited to, tricine, creatine, guanidineacetic acid, and compounds of Structure (1a)

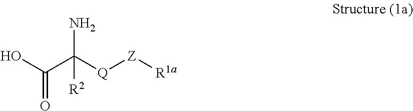

wherein Q, Z, and R² are as described above and R^{1a} is an imidazolyl, H₂N—C(═NR⁴)˜, NH₂NH—C(=NR⁵)˜, amino, hydrazino, or hydroxyl group, or a C₁-C₅ alkyl group substituted with at least one functional group selected from the group consisting of imidazolyl, guanido, amino, hydrazino, or hydroxyl group, in which R⁴ and R⁵ are as described above.

Examples alpha amino carboxylic acids of Structure (1a) include, but are not limited to, arginine, histidine, canavanine, 2,3-diaminopropionic acid, serine, homoserine, 5-hydroxylysine, mimosine, 2,4-diaminobutyric acid, ornithine, 2-methylornithine, lysine and N-ε-methyllysine.

Most preferred alpha amino carboxylic acids of this disclosure include, but are not limited to, creatine, guanidineacetic acid, and compounds of Structure (1b)

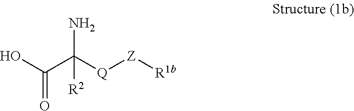

wherein Q, Z, and R² are as described above and R^{1b} is an imidazolyl, H₂N—C(═NR⁴)˜, or NH₂NH—C(═NR⁵)˜ group, or a C₁-C₅ alkyl group substituted with at least one functional group selected from the group consisting of imidazolyl or guanido, in which R⁴ and R⁵ are as described above.

Examples of alpha amino carboxylic acids of Structure (1b) include, but are not limited to, arginine, histidine and canavanine.

In the cleaning composition of the present disclosure, the alpha amino carboxylic acid is present in the range between about 0.01% and about 15%. Preferably the alpha amino carboxylic acid is employed in the range of about 0.1% and about 8%. A more preferred range of the alpha amino carboxylic acid concentration is about 0.5% to about 4% and the most preferred range is between about 1% to about 3%.

The alpha amino carboxylic acid added to the cleaning composition of the present disclosure may be a blend of two or more alpha amino carboxylic acids. If such is the case, the alpha amino carboxylic acids could be mixed in any suitable ratio.

The alpha amino carboxylic can be acquired from commercial chemical suppliers or by known laboratory or biological synthetic methods.

The cleaning composition of the present disclosure further comprises at least one hydroxycarboxylic acid containing at least two carboxyl groups and at least one hydroxyl group, but not containing an amino group alpha to a carboxylic acid group. Examples include, but are not limited to, hydroxycarboxylic acids with two carboxyl groups and one hydroxyl group, such as malic acid, citramalic acid, 2-isopropylmalic acid, 2-hydroxymalonic acid, 3-hydroxy-3-methylglutaric acid, 2-(2-hydroxyethoxy)-propanedioic acid, 2-hydroxy-3-methoxy-butanedioic acid, 2-hydroxy-2-(2-hydroxyethyl)-propanedioic acid and 2-hydroxy-2-(hydroxymethyl)-butanedioic acid; hydroxycarboxylic acids with two carboxyl groups and two hydroxyl groups, such as tartaric acid, dihydroxyfumaric acid, dihydoxymalonic acid, 2-(carboxyhydroxymethoxy)-3-hydroxy-propanoic acid, 2,3-dihydroxy-2-methyl butanedioic acid, 2-deoxy-pentaric acid, 2,2-bis(hydroxymethyl)-propanedioic acid and 2-hydroxy-3-(hydroxymethyl)-butanedioic acid; hydroxycarboxylic acids with two carboxyl groups and three hydroxyl groups, such as arabinaric acid, 2,3-dihydroxy-2-(hydroxymethyl)-butanedioic acid, 2-(1,2-dihydroxyethyl)-2-hydroxy propanedioic acid; hydroxycarboxylic acids with two carboxyl groups and four or more hydroxyl groups, such as D-saccharic acid and mucic acid; hydroxycarboxylic acids with three or more carboxyl groups and one hydroxyl group, such as agaric acid, citric acid, 2-hydroxy-1,1,1-ethanetricarboxylic acid, 2-hydroxy-1,1,3-propanetricarboxylic acid, 1-hydroxy-2-pentene-1,2,5-tricarboxylic acid, dihydro-4-hydroxy-5-oxo-2,2,4 (3H)-furantricarboxylic acid, 3-C-carboxy-2,4-dideoxy-2-methyl-D-threo-pentaric acid, 3-hydroxy-3-methyl-1,1,4-butanetricarboxylic acid, 5-hydroxy-2-pentene-1,2,5-tricarboxylic acid, 3-hydroxy-1,3,4-butanetricarboxylic acid, 2-hydroxy-3-pentene-1,2,3-tricarboxylic acid, 2-hydroxy-1,2,4-butanetricarboxylic acid, and 3-hydroxy-1-oxo-1,3,5-pentanetricarboxylic acid; hydroxycarboxylic acids with three carboxyl groups and two or more hydroxyl group, such as tetrahydro-2,4-dihydroxy-6-methyl-2H-pyran-2,4,6-tricarboxylic acid, 3-C-carboxy-2-deoxy-pentaric acid, 3-C-carboxy-2-deoxy-D-threo-pentaric acid, 1,3-dihydroxy-1,1,3-propanetricarboxylic acid, 1,2-dihydroxy-1,1,2-ethanetricarboxylic acid, 4,6-dihydroxy-5-methyl-1,2,3-benzenetricarboxylic acid, 1,3-dihydroxy-1,2,4-butanetricarboxylic acid, 1,4-dihydroxy-1,2,4-butanetricarboxylic acid, and 1,2,3,4-tetrahydroxy-1,1,4-butanetricarboxylic acid; and hydroxycarboxylic acids with four or more carboxyl groups and one or more hydroxyl group, such as 3-hydroxy-1,1,2,2-cyclobutanetetracarboxylic acid, 1-hydroxy-3-oxo-1,2,4,5-pentanetetracarboxylic acid, 2-hydroxy-1,2,3,4-butanetetracarboxylic acid, tetrahydro-2,6-dihydroxy-2H-Pyran-2,3,5,6-tetracarboxylic acid, 1,4-dihydroxy-1,1,4,4-butanetetracarboxylic acid, 11-hydroxy-5-(hydroxymethyl)-2,4,7,9-Tetraoxaundecane-1,6,8,10-tetracarboxylic acid, 1,3-dihydroxy-1,1,3,3-propanetetracarboxylic acid and 9,10-dihydro-1,4,5,8-tetrahydroxy-9-oxo-10-pentyl-2,3,6,7-acridinetetracarboxylic acid.

Preferred hydroxycarboxylic acids are hydroxycarboxylic acids with two carboxyl groups and two hydroxyl groups, hydroxycarboxylic acids with two carboxyl groups and three hydroxyl groups, hydroxycarboxylic acids with three or more carboxyl groups and one hydroxyl group, and hydroxycarboxylic acids with three or more carboxyl groups and two or more hydroxyl groups.

More preferred hydroxycarboxylic acids are hydroxycarboxylic acids with two carboxyl groups and two hydroxyl groups, hydroxycarboxylic acids with two carboxyl groups and three hydroxyl groups, and hydroxycarboxylic acids with three or more carboxyl groups and one hydroxyl group.

Most preferred hydroxycarboxylic acids are hydroxycarboxylic acids with three or more carboxyl groups and one hydroxyl group.

In the cleaning composition of the present disclosure, the hydroxycarboxylic acid is present in the range between about 0.01% and about 15%. Preferably the hydroxycarboxylic acid is employed in the range of about 0.1% and about 8%. A more preferred range of the hydroxycarboxylic acid concentration in the cleaning composition is about 0.5% to about 4% and the most preferred range is between about 1% to about 4%.

The hydroxycarboxylic acid added to the cleaning composition of the present disclosure may be a blend of two or more hydroxycarboxylic acids. If such is the case the hydroxycarboxylic acid could be mixed in any suitable ratio.

The hydroxycarboxylic acid can be acquired from commercial chemical suppliers or by known laboratory or biological synthetic methods.

The alpha amino acid and the hydroxycarboxylic acid may be blended at a weight ratio of about 95/5 to about 5/95 of the alpha amino acid to the hydroxycarboxylic acid. A preferred blend ratio contains about 80/20 to about 20/80 by weight of the alpha amino acid to the hydroxycarboxylic acid. A more preferred blend ratio is from about 70/30 to about 30/70 by weight and the most preferred blend contains about 60/40 to about 40/60 by weight of either acid.

The present disclosure further comprises at least one hydrazinocarboxylic acid ester (also known as carbazic acid ester or carbazate), which is thought to function as a selective oxidation/reduction agent to improve the dissolution rate of a broad range of otherwise relatively insoluble plasma etch residues. The hydrazinocarboxylic acid ester facilitates the removal of plasma etch residues and is non-corrosive to metals. Hydrazinocarboxylic acid esters employed in the cleaning compositions of the present disclosure are described by Structure (2):

R¹⁰—O—CO—NH—NH₂ Structure (2)

in which R¹⁰ is a substituted or unsubstituted, straight-chain or branched C₁-C₂₀ alkyl group, an optionally substituted C₃-C₂₀ cycloalkyl group, or an optionally substituted C₆-C₁₄ aryl group. Examples of R¹⁰ groups include, but are not limited to, methyl, trifluoromethyl, ethyl, 2,2,2-trifluoroethyl, 2,2,2,-trichloroethyl, hydroxyethyl, propyl, iso-propyl, cyclopropyl, n-butyl, iso-butyl, tert-butyl, sec-butyl, cyclobutyl, pentyl, 1-hydroxypentyl, iso-pentyl, neo-pentyl, cyclopentyl, hexyl, cyclohexyl, heptyl, cyclohexylmethyl, cycloheptyl, 2-cyclohexylethyl, octyl, decyl, pentadecyl, eicosyl, benzyl, and phenyl.

Preferably R¹⁰ is a substituted or unsubstituted, straight-chain or branched C₁-C₁₀ alkyl group or an optionally substituted C₃-C₁₀ cycloalkyl group. Examples of preferred R¹⁰ groups include, but are not limited to, methyl, trifluoromethyl, ethyl, 2,2,2-trifluoroethyl, 2,2,2,-trichloroethyl, hydroxyethyl, propyl, iso-propyl, cyclopropyl, n-butyl, iso-butyl, tert-butyl, sec-butyl, cyclobutyl, pentyl, 1-hydroxypentyl, iso-pentyl, neo-pentyl, cyclopentyl, hexyl, cyclohexyl, heptyl, cycicohexylmethyl, cycloheptyl, 2-cyclohexylethyl, octyl, decyl and benzyl.

More preferably R¹⁰ is a phenyl substituted or unsubstituted, straight-chain or branched C₁-C₅ alkyl group or a C₃-C₆ cycloalkyl group. Examples of more preferred R¹⁰ groups include, but are not limited to, methyl, ethyl, propyl, iso-propyl, cyclopropyl, n-butyl, iso-butyl, tert-butyl, sec-butyl, cyclobutyl, pentyl, iso-pentyl, neo-pentyl, cyclopentyl, cyclohexyl and benzyl. Most preferably R¹⁰ is a methyl, ethyl, tert-butyl or benzyl group.

Examples of suitable hydrazinocarboxylic acid esters include, but are not limited to, methyl carbazate, ethyl carbazate, propyl carbazate, iso-propyl carbazate, butyl carbazate, tert-butyl carbazate, pentyl carbazate, decyl carbazate, pentadecyl carbazate, eicosyl carbazate, benzyl carbazate, phenyl carbazate and 2-hydroxyethyl carbazate. Preferred examples of hydrazinocarboxylic acid esters include, but are not limited to, methyl carbazate, ethyl carbazate, propyl carbazate, iso-propyl carbazate, butyl carbazate, tert-butyl carbazate, pentyl carbazate, decyl carbazate, 2-hydroxyethyl carbazate, and benzyl carbazate. More preferred examples of hydrazinocarboxylic acid esters include, but are not limited to, methyl carbazate, ethyl carbazate, propyl carbazate, iso-propyl carbazate, butyl carbazate, tert-butyl carbazate, pentyl carbazate and benzyl carbazate. Methyl carbazate, ethyl carbazate, tert-butyl carbazate and benzyl carbazate are the most preferred hydrazinocarboxylic acid esters.

In the cleaning composition of the present disclosure, the optional hydrazinocarboxylic acid ester can be present in the range between about 0.01% and about 10%. Preferably the hydrazinocarboxylic acid ester is employed in the range of about 0.1% and about 7.5%. A more preferred range of the hydrazinocarboxylic acid ester concentration in the cleaning composition is about 0.5% to about 5% and the most preferred range is between about 1% to about 4%.

The hydrazinocarboxylic acid ester added to the cleaning composition of the present disclosure may be a blend of two or more hydrazinocarboxylic acid esters. If such is the case the hydrazinocarboxylic acid esters could be mixed in any suitable ratio.

Hydrazinocarboxylic acid esters can be purchased commercially or prepared by a process described in U.S. Pat. No. 5,756,824, which is incorporated herein by reference in its entirety.

The cleaning composition of the present disclosure further includes one or more alkanolamines. Alkanolamines and especially salts of alkanolamines are used in many industrial applications, like water systems and oil pipelines, to prevent metal corrosion. In the composition of the present disclosure the alkanolamines serve primarily as pH adjusters. They are, however, likely to form salts with the alpha amino acid and the hydroxycarboxylic acid which may provide additional metal corrosion protection to the cleaning composition.

Alkanolamines as used in the present disclosure are defined as chemical compounds that carry hydroxyl and amino functional groups on an alkane backbone. As illustrated by the compounds described below, the amino groups may be terminal to the alkane chain, pendant from the alkane chain, within the alkane chain, or part of a cyclic saturated ring.

Examples of alkanolamines include, but are not limited to, diamines and triamines, such as 1,3-diamino-2-hydroxypropane, 2-(2-aminoethylamino)ethanol, 2-((2-(dimethylamino)ethyl)-methylamino)ethanol, 1,3-bis(dimethylamino)-2-propanol, N,N′-bis(2-hydroxyethyl)-ethylenediamine, N,N,N′,N′-tetrakis(2-hydroxy-propyl)ethylenediamine, 1,3-bis(tris(hydroxymethyl)methylamino)propane, 1-(2-hydroxyethyl)piperazine, 1,4-bis(2-hydroxyethyl)-piperazine, 1-(2-(2-hydroxyethoxy)ethyl)-piperazine, 1-amino-4-(2-hydroxylethyl)-piperazine; arylamines such as 2-amino-3-phenyl-1-propanol, 2-amino-1-phenyl-1-propanol, 2-amino-1-phenyl-1,3-propanediol, α-aminomethyl-4-hydroxybenzyl alcohol, α-(1-aminoethyl)-4-hydroxybenzyl alcohol, 2-amino-1-phenylethanol, benzyl-L-cysteinol, 2-amino-3-methoxy-1-phenyl-1-propanol, α-(aminomethyl)-4-hydroxybenzyl alcohol, thiomicamine, α-(1-methylaminoethyl)benzyl alcohol, (methylaminomethyl)benzyl alcohol, 3-hydroxy-α-(methylaminomethyl)benzyl alcohol, 4-hydroxyephedrine, 4-hydroxy-4-phenylpiperidine, 1-benzyl-4-hydroxypiperidine, 3-(N-benzyl-N-methylamino)-1,2-propanediol, N-benzyl-N-methylethanolamine, 3-(dibenzylamino)-1-propanol, 2-(N-ethyl-meta-toluidino)-ethanol, 2,2′-(p-tolylimino)diethanol, 3-(N-benzyl-N-methylamino)-1,2-propanediol, 1-benzyl-3-pyrrolidinol, 1-benzyl-2-pyrrolidinemethanol, and alkanolamines of Structure (3):

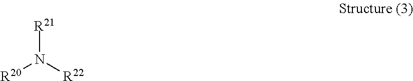

in which R²⁰, R²¹, and R²² are independently a hydrogen atom, a linear, branched or cyclic alkyl optionally substituted by one or more hydroxyl group and optionally containing an oxygen atom in its chain; with the proviso that at least one of R²⁰, R²¹, and R²² contains at least one hydroxyl group. In addition, any two of the R²⁰, R²¹, and R²² groups, together with the nitrogen atom to which they are attached, can form a C₃-C₁₄ cyclic structure (e.g., a substituted or unsubstituted ring or two or more substituted or unsubstituted ring that are fused together).

The alkanolamines of Structure (3) can be primary alkanolamines wherein R²⁰ and R²¹ are hydrogen atoms and R²² is a linear, branched or cyclic alkyl which is substituted by one or more hydroxyl groups and may contain an oxygen atom in its chain. Examples of these alkanolamines include, but are not limited to, 4-amino-1-butanol, 2-(2-aminoethoxy)ethanol, ethanolamine, 3-amino-1-propanol, 2-amino-1-propanol, 1-amino-2-propanol, 2-amino-1-butanol, 2-amino-2-methyl 1-propanol, 2-(2-aminoethoxy)propanol, 5-amino-1-pentanol, 2-amino-1-pentanol, 2-amino-3-methyl-1-butanol, 2-amino-1-hexanol, isoleucinol, leucinol, 1-amino-1-cyclopentanemethanol, trans-2-aminocyclohexanol, trans-4-aminocyclohexanol, 3-aminomethyl-3,5,5-trimethylcyclohexanol, 1-aminomethyl-1-cyclohexanol, 6-amino-1-hexanol, 6-amino-2-methyl-2-heptanol, 4-amino-4-(3-hydroxypropyl)-1,7-heptanediol, serinol, 3-amino-1,2-propanediol, 2-amino-2-ethyl-1,3-propanediol, 2-amino-2-methyl-1,3-propanediol, tris(hydroxymethyl)-aminomethane, 1-amino-1-deoxy-D-sorbitol and bis(hydroxyethoxyethyl)amine. More preferably R²² in the primary alkanolamine is a linear, branched or cyclic alkyl which is substituted by one hydroxyl group and may contain an oxygen atom in its chain. Examples of these alkanolamines include, but are not limited to, 4-amino-1-butanol, 2-(2-aminoethoxy)ethanol, ethanolamine, 3-amino-1-propanol, 2-amino-1-propanol, 1-amino-2-propanol, 2-amino-1-butanol, 2-amino-2-methyl 1-propanol, 2-(2-aminoethoxy)propanol, 5-amino-1-pentanol, 2-amino-1-pentanol, 2-amino-3-methyl-1-butanol, 2-amino-1-hexanol, isoleucinol, leucinol, 1-amino-1-cyclopentanemethanol, trans-2-aminocyclohexanol, trans-4-aminocyclohexanol, 3-aminomethyl-3,5,5-trimethylcyclohexanol, 1-aminomethyl-1-cyclohexanol, 6-amino-1-hexanol, and 6-amino-2-methyl-2-heptanol. Most preferably the R²² residue in the primary alkanolamine is a linear, branched or cyclic C₁-C₄ alkyl which is substituted by one hydroxyl group and may contain an oxygen atom in its chain. Examples of these alkanolamines include, but are not limited to, 4-amino-1-butanol, 2-(2-aminoethoxy)ethanol, ethanolamine, 3-amino-1-propanol, 2-amino-1-propanol, 1-amino-2-propanol, 2-amino-1-butanol, and 2-amino-2-methyl 1-propanol.

Alternatively the alkanolamine of Structure (3) can be a secondary primary alkanolamine wherein R²⁰ is a hydrogen atom and R²¹ and R²² are each independently a linear, branched or cyclic alkyl which may be substituted by one or more hydroxyl group and may contain an oxygen atom in its chain; with the proviso that at least one of R²¹ and R²² contains at least one hydroxyl group. Examples of these alkanolamines include, but are not limited to, 2-(methylamino)ethanol, 2-(ethylamino)ethanol, 2-(propylamino)ethanol, 2-(tert-butylamino)ethanol, N-methyl-D-glucamine, 1-deoxy-1-(methylamino)-D-galactitol, 3-pyrrolidinol, 2-pyrrolidinemethanol, 2-piperidinemethanol, 2-piperidineethanol, 3-hydroxypiperidine, 3-piperidinemethanol, 4-hydroxypiperidine, 2,2,6,6-tetramethyl-4-piperidinol, diethanolamine, diisopropanolamine, disorbitylamine, and 1-deoxy-1-(2-hydroxyethylamino)-D-glucitol. More preferably R²¹ and R²² are each independently a linear, branched or cyclic alkyl substituted by one or more hydroxyl group. Examples of these alkanolamines include, but are not limited to, diethanolamine, diisopropanolamine, disorbitylamine, and 1-deoxy-1-(2-hydroxyethylamino)-D-glucitol. Most preferably R²¹ and R²² are each independently a linear, branched or cyclic alkyl substituted by one hydroxyl group. Examples of these alkanolamines include, but are not limited to, diethanolamine and diisopropanolamine.

Another type of alkanolamine of Structure (3) is a tertiary alkanolamine, wherein R²⁰, R²¹ and R²² are each independently a linear, branched or cyclic alkyl which may be substituted by one or more hydroxyl group and may contain an oxygen atom in its chain; with the proviso that at least one of R²⁰, R²¹ and R²² contains at least one hydroxyl group. Examples of these alkanolamines include, but are not limited to, triethanolamine, trisisopropanolamine, 1-(N,N-bis(2-hydroxyethyl)-amino)-2-propanol, N-butyldiethanolamine, N-methyldiethanolamine, N-ethyldiethanolamine, 2-(dibutylamino)ethanol, 5-diethylamino-2-pentanol, N,N-dimethyl-2-(2-aminoethoxy)ethanol, 4-(2-hydroxyethyl)morpholine, 3-morpholino-1,2-propanediol, N,N-dimethylethanolamine, N-N-diethylethanolamine, 2-(diisopropylamino)ethanol, 3-dimethylamino-1-propanol, 3-diethylamino-1-propanol, 1-dimethylamino-2-propanol, 1-diethylamino-2-propanol, 3-(dimethylamino)-1,2-propanediol, 3-(diethylamino)-1,2-propanediol, 3-(dipropylamino)-1,2-propanediol, 3-(diisopropylamino)-1,2-propanediol, 1-aziridineethanol, 1-(2-hydroxyethyl)-pyrrolidine, 3-pyrrolidino-1,2-propanediol, 1-methyl-3-pyrrolidinol, 1-ethyl-3-pyrrolidinol, 1-methyl-2-pyrrolidinemethanol, 1-methyl-2-pyrrolidineethanol, 1-piperadineethanol, 3-piperidino-1,2-propanediol, 1-methyl-2-piperidinemethanol, 3-hydroxy-1-methylpiperidine, 1-ethyl-3-hydroxypiperidine, 1-methyl-3-piperidinemethanol, 4-hydroxy-1-methylpiperidine, and 1-ethyl-4-hydroxypiperidine. More preferably R²⁰, R²¹ and R²² are each independently a linear, branched or cyclic alkyl which may be substituted by one or more hydroxyl group; with the proviso that at least two of R²⁰, R²¹ and R²² contain at least one hydroxyl group. Examples of these alkanolamines include, but are not limited to, triethanolamine, trisisopropanolamine, 1-(N,N-bis(2-hydroxyethyl)-amino)-2-propanol, N-butyldiethanolamine, N-methyldiethanolamine, and N-ethyldiethanolamine. Most preferably R²⁰, R²¹ and R²² are each independently a linear, branched or cyclic alkyl substituted by one or more hydroxyl group. Examples of these alkanolamines include, but are not limited to, triethanolamine, trisisopropanolamine, and 1-(N,N-bis(2-hydroxyethyl)-amino)-2-propanol.

The preferred alkanolamines of the present disclosure are alkanolamines of Structure (3). More preferred are secondary alkanolamines of Structure (3) and tertiary alkanolamines of Structure (3), while tertiary alkanolamines of Structure (3) are most preferred.

The pH of the cleaning composition is between about 6 and about 10. The preferred pH range is between about 6.5 and about 9.5. More preferably the pH is adjusted to fall between about 6.5 and about 8.5. Most preferably the pH is between about 7 and about 9 or between about 7 and about 8. Without wishing to be bound by theory, it is believed that when the pH of the cleaning composition described in the present disclosure is too low (e.g., less than about 6), the composition generally has a poor cleaning capability. On the other hand, when the pH of the cleaning composition described in the present disclosure is too high (e.g., more than about 10), it is believed that the anti-corrosion effect of the alpha amino carboxylic acid in the clean composition is significantly inhibited.

In the cleaning composition of the present disclosure, the alkanolamine is present in an amount sufficient to adjust the pH to the desired value and thus will depend on the concentration of the alpha amino acid and hydroxycarboxylic acid and their acid strength as well as the presence of optional components affecting the pH of the cleaning composition. Typically, the alkanolamine is present in the cleaning composition of the present disclosure between about 0.1% and about 15%. Preferably the concentration of the alkanolamine is between about 0.1% and about 10%. More preferably the alkanolamine is added to the cleaning composition in an amount of about 0.5% and about 6% and most preferably the alkanolamine is employed in the cleaning composition at between about 1% and about 4%.

The alkanolamine added to the cleaning composition of the present disclosure may be a blend of two or more alkanolamines. If such is the case the alkanolamines could be mixed in any suitable ratio.

The alkanolamines can be acquired from commercial chemical suppliers or by known synthetic methods.

The cleaning composition of the present disclosure further includes water. Preferably, the water is de-ionized and ultra-pure, containing no organic contaminants and has a minimum resistivity of about 4 to about 17 mega Ohms. More preferably, the resistivity of the water is at least 17 mega Ohms. The water present in the cleaning composition ranges between about 45% and about 99.7%. Preferably the water is employed in the range of about 65% and about 98%. A more preferred range of the water concentration in the cleaning composition is about 70% to about 95% and the most preferred range is between about 80% to about 92%.

In addition, the cleaning composition of the present disclosure may contain additives such as, additional pH adjusters other than the alkanolamines described above, corrosion inhibitors not containing a carboxyl group, surfactants, organic solvents, de-foaming agents, and biocides may be included as optional components.

Optionally, one or more pH adjusting agents other than alkanolamine may be added to the cleaning composition or this disclosure. Examples of additional classes of pH adjusting agents useful for the cleaning composition of the present disclosure include, but are not limited to, alkylamines, such as methylamine, ethylamine, propylamine, isopropylamine, butylamine, isobutylamine, tert-butylamine, amylamine, isoamylamine, hexylamine, heptylamine, octylamine, ethylene diamine, 1,3-diaminepropane, 1,2-diaminepropane, 1,4-diaminobutane, 1,6 hexanediamine, dimethylamine, N-ethylmethylamine, diethylamine, N-methylpropylamine, N-methylisopropylamine, dipropylamine, diisopropylamine, N-methylpropylamine, dibutylamine, diisobutylamine,dipentylamine, trimethylamine, N,N-dimethhylethylamine, N,N-diethylmethylamine, triethylamine, tripropylamine, N,N-dimethylisopropylamine, N,N-diisopropylmethylamine, N,N-dimethylbutylamine, tributylamine, N,N,N′N′-tetramethyldiaminomethane, N-ethylethylenediamine, diethylenetriamine, cyclohexylamine and trans, 1-4-diaminocyclohexane; arylamines, such as aniline, N-ethylaniline, 1,4-phenylenediamine and 3-aminophenyl; hydrazines such as tert-butylhydrazine, 1,2-dimethylhydrazine, 1,1-dimethylhydrazine, 1,2-diethylhydrazine, and quaternary ammonium hydroxides, such as tetramethylammonium hydroxide, tetraethylammonium hydroxide, tetrapropylammonium hydroxide, tetrabutylammonium hydroxide, triethylmethylammonium hydroxide, dimethyldiethylammonium hydroxide, trimethyl hydroxyethylammonium hydroxide, methyl tri(hydroxyethyl)ammonium hydroxide, benzyltrimethylammonium hydroxide, phenyltrimethylammonium hydroxide.

If added, the optional pH adjuster is added together with the alkanolamine in sufficient amount to adjust the cleaning formulation to the desired pH.

The cleaning composition of the present disclosure may, optionally, include one or more corrosion inhibitors not containing carboxyl groups. These corrosion inhibitors can be added to the composition to further inhibit corrosion of exposed metal layers on the semiconductor device, such as aluminum, copper, tungsten, alloys of these metals, and other exposed metals. There are at least three mechanisms in which these compounds aid to inhibit corrosion: 1) they may contain ligands other than carboxyl groups, such as, alkyl or aryl ammonium ion functional groups, hydroxyl, amino, imido, nitrino, thio, mercapto, and carbonyl groups and, therefore, have chelating properties, 2) they may have antioxidant properties and prevent the formation of metal oxides or 3) they may form a protective layer on the metal. The addition of one or more of these optional corrosion inhibitors may also improve the cleaning response.

Corrosion inhibitors not containing carboxyl groups useful in the compositions of the present disclosure, include but are not limited to, the following: ascorbic acid, vanillin, uric acid, butyne diols, benzotriazole, triazole, glucose, imidazole, 2-butyne-1,4-diol, ketones such as cyclohexenyl acetone and 3-nonene-2-one, tetramisole, hydrazine and its derivatives, such as, methyl, ethyl, propyl, hydroxymethyl, hydroxyethyl, hydroxypropyl, dihydroxyethyl, methoxy, maleic and phenyl hydrazine, oximes such as acetone oxime, salicylaldoxime and butanone oxime, readily oxidized aromatic compounds and oxidation inhibitors, such as, hydroquinone, pyrogallol, hydroxytoluene, 4-methoxyphenyl, and 4-hydroxymethylphenol, thiols such as mercaptoethanol, 2-propene-1-thiol, thioglycerol, 1H-1,2,4-triazole-3-thiol, mercaptomethylimidazole, mercaptothiazoline, 2-mercapto-4 [3H] quinazoline and 2-thiobarbituric acid, aldehydes and derivatives thereof, such as salicylaldehyde, and 4-hydroxybenzaldehyde, glycol aldehyde dialkyl acetals, particularly glycol aldehyde diethyl acetal, cationic surfactants such as isostearyl ethylimidonium ethosulfate (monaquat isies) distearydimethylammonium chloride, benzyldimethylstearylammonium chloride, dilauryldimethylammonium bromide, and hexadecyltrimethyl ammonium chloride, and imides such as polyethyleneimide and mixtures thereof.

If employed in the cleaning composition of the present disclosure, the corrosion inhibitors, are added from about 0.001% to about 10%. A more preferred concentration range of the corrosion inhibitors is from about 0.005% to about 8%, and more preferably about 0.01% to about 6%. The most preferred concentration range of the corrosion inhibitor is between about 0.01 to about 4% in the cleaning composition of the present disclosure.

The cleaning composition of the present disclosure may, optionally, include a surfactant to promote even wetting of the semiconductor surface and enhance the power of the plasma etching residue dissolution and removal from the semiconductor substrate. These surfactants can be nonionic (excluding amine oxides), amine oxides, cationic, anionic, zwitterionic, or amphoteric surfactants or mixtures thereof. Suitable nonionic surfactants include those based on ethylene oxide, propylene oxide, or mixtures of both ethylene oxide and propylene oxide. Preferably, surfactants for useful in cleaning composition of the present disclosure have low levels of metallic impurities. An example is an alkylphenol polyglycidol ether type of a non-ionic surfactant, available from Arch Chemicals Inc. under the trade name OHS. If added, the surfactant is present in the cleaning composition of the present disclosure up to about 0.5 wt % (5000 parts per million). Preferably, the surfactant is in the cleaning composition from about 0.0005 wt % (5 ppm) to about 0.22 wt % (2200 ppm). More preferably, the surfactant is in the cleaning composition from about 0.001 wt % (10 ppm) to about 0.1 wt % (1000 ppm). The most preferred surfactant concentration in the cleaning composition is between about 0.001 wt % (10 ppm) to about 0.05 wt % (500 ppm).

The cleaning composition of the present disclosure may further optionally include organic solvents. If employed, these organic solvents can be added to the cleaning composition up to about 30% with the proviso that in the quantity added, a homogeneous solution is formed. Examples of organic solvents, which may be suitable, include, but are not limited to, sulfolane, dimethyl sulfoxide, 1,3-dimethyl-2-imidazolidinone, gamma butyrolactone, glycols such as propylene glycol, propylene glycol monomethyl ether, propylene glycol monoethyl ether, propylene glycol mono-n-propyl ether, propylene glycol mono-n-butyl ether, propylene glycol mono-t-butyl ether, dipropylene glycol monomethyl ether, dipropylene glycol dimethyl ether, dipropylene glycol mono-n-butyl ether, dipropylene glycol mono-t-butyl ether, dipropylene glycol mono-n-propyl ether, tripropylene glycol monomethyl ether, tripropylene glycol mono-n-propyl ether, tripropylene glycol mono-n-butyl ether, ethylene glycol, ethylene glycol monoethyl ether, ethylene glycol monomethyl ether and ethylene glycol monobutyl ether; ketones such as methyl isobutyl ketone, methyl-n-propyl ketone and methyl ethyl ketone; alcohols such as ethanol, isopropanol, butanol, 1,4-butanediol, glycerol, tetrahydrofurfuryl alcohol and ethyl lactate; nitriles such as acetonitrile and benzonitrile; and amides such as dimethyl formamide, dimethyl acetamide, formamide, N-methyl pyrrolidone, N-ethyl pyrrolidone and cyclohexylpyrrolidone.

The cleaning composition of the present disclosure may further optionally include additives that are designed to reduce foaming. If employed, the antifoaming agent may be employed up to about 20 wt % of the total surfactant concentration. Examples of defoamers, which may be suitable, include, but are not limited to, DeFoamer WB 500 (available from Tech Sales Co.), NoFoam 1971 (available from Oil Chem Technology), Tego Foaqmex (available from DeGusa), Surfynol 104 (available from Air-Products), SAG 10 (available from OSi Specialties, Inc.), and Advantage 831 (available from Hercules).

The cleaning composition of the present disclosure may also include antimicrobial additives (e.g., bactericides, algicides or fungicides). Examples of antimicrobial agents which might be employed include, but are not limited to, Kathon CG, Kathon CG II, and NEOLONE 950 Bactericide (available from Rohm and Haas), methylisothiazolinone, and the AQUCAR series of products (available from Dow Chemical). If employed in the cleaning composition, the typical range of concentration of antimicrobial agent would be from about 0.0001 wt % to about 0.5 wt %.

Preferably, the cleaning composition of the present disclosure is free of components containing fluorides, abrasives and oxidizers.

The term “fluorides” used herein refers to compounds having a fluoride ion or compounds that may react with an ingredient in the cleaning composition of the present disclosure to form a fluoride ion (e.g., an acyl fluoride reacting with water to form hydrogen fluoride). Examples of such fluorides include acid fluorides and fluoride salts. Examples of acid fluorides include hydrogen fluoride, perfluoric acid, and a mixture thereof. Examples of fluoride salts include metal fluorides (e.g., KF, NaF, CsF, MgF₂, or CaF₂) and organic fluoride salts (e.g., ammonium fluoride, ammonium bifluoride, tetraalkyl ammonium fluoride salts such as tetramethyl ammonium fluoride and tetraethyl ammonium fluoride, polyammonium fluorides such as ethylenediammonium difluoride and diethylemtriammonium trifluoride, hydrogen fluoride pyridine salt, hydrogen fluoride imidazole salt, hydrogen fluoride polyvinylpyridine salt, hydrogen fluoride polyvinylimidazole salt, and hydrogen fluoride polyallylamine salt).

The term “abrasive” used herein refers to materials typically insoluble or only partially soluble (e.g., less than 1 mg/mL at ambient temperature) in aqueous based systems and includes materials typically used in polishing operations such as the polishing of lenses, optical elements, and chemical mechanical polishing. Examples of such abrasives include oxides such as metal oxides. Suitable oxides include colloidal silica, silica, alumina, cerium oxide, zirconia, aluminosilicates, iron oxides, and other insoluble metal oxides.

The term “oxidizer” used herein refers to compounds commonly used to oxidize other chemical compounds in chemical processes. Examples of such compounds include hydrogen peroxide, percarboxylic acids (e.g., peracetic acid), hypochlorites, persulfates, iodates, periodates, bromates, halogens, nitrates, and various metal salts and oxides, as well as mixtures of these compounds.

As the cleaning composition of the present disclosure is useful in integrated circuit device manufacturing processes, care must be taken to provide cleaning compositions with low metallic impurities. Preferably, these cleaning compositions should not exceed total metal ion contamination levels of 10 ppm. More preferred are cleaning compositions that have total metal ion contamination levels of 5 ppm or less. Most preferred are cleaning compositions that have total metal ion contamination levels not exceeding 1 ppm.

Illustrative compositions of this disclosure are presented in Table 1 below. All formulations would be prepared as described in the experimental section, GENERAL PROCEDURE 1 (Formulation blending). No amounts are given for the addition of alkanolamine. This component will be added in the amount sufficient to adjust the pH to the desired value as outlined in the procedure.

TABLE 1
Illustrative Compositions of the Disclosure

| alpha | hydroxycarboxylic | | | | |
|---|---|---|---|---|---|
| Amino acid | acid | carbazate | alkanolamine* | other | pH |
| 2% | 1.3% | 1.5% | N′N′-bis(2- | 0.2% | 7.5 |
| histidine | tartaric acid | ethyl | hydroxyethyl)- | Monaqkuat | |
| | | carbazate | ethylenediamine | Isies | |
| 4% | 1% | 2% | 2-amino-3- | | 8.0 |
| arginine | malic acid | methyl | phenyl-1- | | |
| | | carbazate | propanol | | |
| 1% | 2.3% | 0.5% | 3-amino-1,2- | 2% | 7.5 |
| guanidineacetic | agaric acid | t-butyl | propanediol | ascorbic acid | |
| acid | | carbazate | | | |
| 8% | 0.9% | 2%/2% | 2-2- | | 7.8 |
| creatine | 3-hydroxy-3- | ethyl/methyl | (aminoethoxy)propanol | | |
| | methylglutaric acid | carbazate | | | |
| 3% | 4% | 0.5% | 3-amino-1- | 0.2% | 7.5 |
| serine | dihydroxyfumaric acid | methyl | propanol | SBDMA | |
| | | carbazate | | | |
| 3% | 8% | 0.1% | 2-(methylamino)ethanol | 10% | 7.0 |
| cysteine | citric acid | t-butyl | | dipropylene | |
| | | carbazate | | glycol | |
| | | | | monomethyl | |
| | | | | ether | |
| 0.5% | 0.5% | 7.5% | N-methyl-D- | | 7.5 |
| guanidineacetic | 1,3-dihydroxy-1,1,3- | ethyl | glucamine | | |
| acid | propanetricarboxylic | carbazate | | | |
| | acid | | | | |
| 1% | 1% | 2% | disorbitylamine | 100 ppm | 8.0 |
| lysine | arabinaric acid | methyl | | OHS | |
| | | carbazate | | | |
| 3% | 1.5% | 1% | diethanolamine | | 7.5 |
| asparagine | mucic acid | t-butyl | | | |
| | | carbazate | | | |
| 2% | 3% | 2% | N,N- | 1% | 7.5 |
| serine | malic acid | ethyl | diemethylethanol | Monaquat | |
| | | carbazate | amine | Isies | |
| 2% | 2% | 0.5%/0.5% | N,N-dimethyl-2- | | 7.5 |
| histidine | tartaric | methyl/ethyl | (2-aminoethoxy)ethanol | | |
| | | carbazate | | | |
| 6% | 6% | 3% | N-ethyldiethanol | 1000 ppm | 8.0 |
| ysine | citric | methyl | amine | OHS | |
| | | carbazate | | | |
| 6% | 2% | 0.5% | bis(hydroxyethoxyethyl)amine | 0.5% | 8.0 |
| ornithine | 1,4-dihydroxy- | ethyl | | trimethylamine | |
| | 1,1,4,4- | carbazate | | | |
| | butanetetracarboxylic | | | | |
| | acid | | | | |
| 2% | 1% | 1.5%/0.5% | TEA | 0.5% | 8.0 |
| canavanine | 2-hydroxy-1,2,3,4- | ethyl/benzyl | | BzTMAH | |
| | butanetetracarboxylic | carbazate | | | |
| | acid | | | | |
| 1% | 2%/1% | 1.5% | diethanolamine | | 7.5 |
| arginine | citric/tartaric | methyl | | | |
| | | carbazate | | | |
| 1% | 3% | 1% | 50/50 mixture | | 6.5 |
| tyrosine | 2-deoxy-pentaric acid | ethyl | TEA/MEA | | |
| | | carbazate | | | |
| 1%/1.5% | 2% | 0.3% | leucinol | 1% | 8.5 |
| lysine/serine | malic | t-butyl | | TMAH | |
| | | carbazate | | | |

Note:
Monaquat Isies is isostearylethylimidazolinium ethosulfate,
SBDMA is stearylbenzyldimethylammonium chloride,
BzTMAH is benzyl trimethylammonium hydroxide solution,
TEA is triethanolamine and
MEA is monoethanolamine.

The cleaning composition of the present disclosure is not specifically designed to remove bulk photoresist films from semiconductor substrates. Rather the cleaning composition of the present disclosure is designed to remove all residues after bulk resist removal by dry or wet stripping methods. Therefore, the cleaning method of the present disclosure is preferably employed after a dry or wet photoresist stripping process. This photoresist stripping process is generally preceded by a pattern transfer process, such as an etch or implant process, or it is done to correct mask errors before pattern transfer. The chemical makeup of the residue will depend on the process or process preceding the cleaning step.

Any suitable dry stripping process can be used, including oxygen based plasma ashing, such as a fluorine/oxygen plasma or a N₂/H₂ plasma; ozone gas phase-treatment; fluorine plasma treatment, hot H₂ gas treatment (described in U.S. Pat. No. 5,691,117 incorporated herein by reference in its entirety), and the like. In addition any conventional organic wet stripping solution can be used known to a person skilled in the art.

The preferred stripping process used in combination with the cleaning method of the present disclosure is a dry stripping process. Preferably this dry stripping process is the oxygen based plasma ashing process. This process removes most of the photoresist from the semiconductor substrate by applying a reactive-oxygen atmosphere at elevated temperatures (typically 250° C.) at vacuum conditions (i.e. 1 torr). Organic materials are oxidized by this process and are removed with the process gas. However, this process does not remove inorganic or organometallic contamination for the semiconductor substrate. A subsequent cleaning of the semiconductor substrate with the cleaning composition of the present disclosure is necessary to remove those residues.

One embodiment of the present disclosure is the method of cleaning residues from a semiconductor substrate comprising the steps of:
(A) providing a semiconductor substrate containing post etch and/or post ash residues;
(B) contacting said semiconductor substrate with a cleaning composition comprising: (a) at least one alpha amino carboxylic acid containing at least one additional functional group capable of chelating metals with the proviso that the alpha amino carboxylic acid does not contain an additional carboxyl group; (b) at least one hydroxycarboxylic acid containing at least two carboxyl groups and at least one hydroxyl group; (c) at least one hydrazinocarboxylic acid ester; (d) at least one alkanolamine, and (e) water; with the provisos that the hydroxycarboxylic acid does not contain an amino group alpha to a carboxylic acid group, in which the pH of the composition is between about 6 and about 10;
(C) rinsing said semiconductor substrate with a suitable rinse solvent; and
(D) optionally, drying said semiconductor substrate by any means that removes the rinse solvent and does not compromise the integrity of the semiconductor substrate including the elements on the substrate (e.g., does not cause corrosion or etch the substrate).

In addition, the cleaning composition used in step (B) of the method of the present disclosure can optionally contain additional additives, such as pH adjusters, corrosion inhibitors not containing a carboxyl group, surfactants, de-foaming agents, and biocides.

The semiconductor substrates to be cleaned in this method contain organic and organometallic residues, and additionally, a range of metal oxides that need to be removed. Semiconductor substrates typically are constructed of silicon, silicon germanium, Group III-V compounds like GaAs, or any combination thereof. The semiconductor substrates may additionally contain exposed integrated circuit structures such as interconnect features like metal lines and dielectric materials. Metals and metal alloys used for interconnect features include, but are not limited to, aluminum, aluminum alloyed with copper, copper, titanium, tantalum, cobalt, and silicon, titanium nitride, tantalum nitride, and tungsten. Said semiconductor substrate may also contain layers of silicon oxide, silicon nitride, silicon carbide and carbon doped silicon oxides.

The semiconductor substrate can be contacted with the cleaning composition by any suitable method, such as by placing the cleaning composition into a tank and immersing and/or submerging the semiconductor substrates into the cleaning composition, spraying the cleaning composition onto the semiconductor substrate, streaming the cleaning composition onto the semiconductor substrate, or any combinations thereof. Preferably, the semiconductor substrates are immersed into the cleaning composition.

The cleaning compositions of the present disclosure may be effectively used up to a temperature of about 90° C. Preferably, the cleaning composition is used from about 50° C. to about 80° C. More preferably the cleaning composition is employed in the temperature range from about 55° C. to about 75° C. and most preferred is a temperature range of about 60° C. to about 70° C.

Similarly, cleaning times can vary over a wide range depending on the particular cleaning method and temperature employed. When cleaning in an immersion batch type process, a suitable range is, for example, up to about 60 minutes. A preferred range for a batch type process is from about 3 minutes to about 60 minutes. A more preferred range for a batch type process is from about 9 minutes to about 60 minutes. A most preferred range for a batch type cleaning process is from about 9 minutes to about 45 minutes.

Cleaning times for a single wafer process may range from about 10 seconds to about 5 minutes. A preferred cleaning time for a single wafer process may range from about 15 seconds to about 4 minutes. A more preferred cleaning time for a single wafer process may range from about 15 seconds to about 3 minutes. A most preferred cleaning time for a single wafer process may range from about 20 seconds to about 2 minutes.

To further promote the cleaning ability of the cleaning composition of the present disclosure, mechanical agitation means may be employed. Examples of suitable agitation means include circulation of the cleaning composition over the substrate, streaming or spraying the cleaning composition over the substrate, and ultrasonic or megasonic agitation during the cleaning process. The orientation of the semiconductor substrate relative to the ground may be at any angle. Horizontal or vertical orientations are preferred.

The cleaning compositions of the present disclosure can be used in conventional cleaning tools, such as the Ontrak Systems DSS, SEZ single wafer spray rinse system, Verteq single wafer megasonic Goldfinger, Semitool Millenium single wafer spray rinse systems, and other toolsets. A significant advantage of the composition of the present disclosure is that it is comprised of relatively non-toxic, non-corrosive, and non-reactive components in whole and in part, whereby the composition is stable in a wide range of temperatures and process times. The composition of the present disclosure is chemically compatible with practically all materials used to construct existing and proposed semiconductor wafer cleaning process tools for batch and single wafer cleaning.

Subsequent to the cleaning, the semiconductor substrate is rinsed with a suitable rinse solvent for about 5 seconds up to about 5 minutes with or without agitation means. Examples of suitable rinse solvents include, but are not limited to, deionized (DI) water, methanol, ethanol, isopropyl alcohol, N-methylpyrrolidinone, gamma-butyrolactone, dimethyl sulfoxide, ethyl lactate and propylene glycol monomethyl ether acetate. Preferred examples of rinse solvents include, but are not limited to, DI water, methanol, ethanol and isopropyl alcohol. More preferred rinse solvents are DI water and isopropyl alcohol. The most preferred rinse solvent is DI water. The rinse solvent may be brought into contact with the semiconductor substrate using means similar to that used in applying the cleaning composition. The cleaning composition may have been removed from the semiconductor substrate prior to the start of the rinsing step or it may still be in contact with the semiconductor substrate at the start of the rinsing step. Preferably, the temperature employed is between 16° C. and 27° C.

Optionally, the semiconductor substrate is then dried. Any suitable drying means known in the art may be employed. Examples of suitable drying means include spin drying, flowing a dry gas across the semiconductor substrate, or heating the semiconductor substrate with a heating means such as a hotplate or infrared lamp, Maragoni drying, rotagoni drying, IPA drying or any combinations thereof. Drying times will be dependent on the specific method employed but are typically on the order of 30 seconds up to several minutes.

In some embodiments, a method of manufacturing an integrated device using a cleaning composition described herein can include the following steps. First, a layer of a photoresist is applied to a semiconductor substrate and lithographic steps performed. The semiconductor substrate thus obtained can then undergo a pattern transfer process, such as an etch or implant process, to form an integrated circuit. The bulk of the photoresist can then be removed by a dry or wet stripping method (e.g., an oxygen based plasma ashing process). Remaining residues on the semiconductor substrate can then be removed using a cleaning composition described herein in the manner described above. The semiconductor substrate can subsequently be processed to form one or more additional circuits on the substrate or can be processed to form into a semiconductor chip by, for example, assembling (e.g., dicing and bonding) and packaging (e.g., chip sealing).

### EXAMPLES

The present disclosure is illustrated in more detail with reference to the following examples, which are for illustrative purposes and should not be construed as limiting the scope of the present disclosure. Any percentages listed are by weight (wt %) unless otherwise specified. Controlled stirring during testing was done with a stir bar at 300 rpm unless otherwise noted.

### General Procedure 1

### Formulation Blending

Samples of the cleaning compositions were prepared by adding, while stirring, to 80-95% of the calculated amount of ultra pure deionized water (DI water) the at least one carboxylic acid, the at least one carbazate and the at least one amino acid. After a uniform solution was achieved the optional additives (except optional pH adjusting agents), if used, were added. Then about 80-95% of the at least one alkanolamine and TMAH or other pH adjuster, if used, was added. The solution was allowed to equilibrate and the pH of the cleaning composition was taken. The solution pH was then adjusted to a target pH by adding more alkanolamine or other pH adjuster such as TMAH. At this point any additional DI water, if needed was added.

The pH measurements were taken at ambient temperature after all components were fully dissolved. All components used were commercially available and of high purity.

### General Procedure 2

### Cleaning Test in Beaker

The wafers were initially surveyed by optical microscopy, and then diced into approximately 1×1 cm² square test coupons for the cleaning tests. The 1×1 cm² coupons were held using 4″ long plastic locking tweezers, whereby the coupon could then be suspended into a 500 ml volume glass beaker containing approximately 250 ml of the cleaning compositions of the present disclosure. Prior to immersion of the coupon into the cleaning composition, the composition was pre-heated to the test condition temperature of 60° C.-70° C. with controlled stirring. The cleaning tests were then carried out by placing the coupon which was held by the plastic tweezers into the heated composition in such a way that the residue containing side of the coupon faced the stir bar. The coupon was left static in the cleaning composition for a period of 30 or 40 minutes while the composition was kept at the test temperature under controlled stirring. Once the coupon was exposed in the composition for the duration of the test, the coupon was quickly removed from the cleaning composition and placed in a 500 ml plastic beaker filled with approximately 400 ml of DI water at ambient temperature (˜17° C.) with gentle stirring. The coupon was left in the beaker of DI water for approximately 30 seconds, and then quickly removed, and rinsed under a DI water stream at ambient temperature for about 30 seconds. Then the coupon was immediately exposed to a nitrogen gas stream from a hand held nitrogen blowing gun which caused any droplets on the coupon surface to be blown off the coupon, and further to completely dry the coupon device surface. Following this final nitrogen drying step, the coupon was removed from the plastic tweezers holder and placed into a covered plastic carrier with the device side up for short term storage no greater than about 2 hours.

The test coupons were then lightly coated with a ˜30 Angstrom thick layer of sputtered platinum, and scanning electron microscopy (SEM) images were collected for key features on the cleaned test coupon device surface.

### Formulation Examples FE1-FE16 and Comparative Formulation Examples CFE1-CFE32

TABLE 2
Cleaning Compositions

| | Component | | | | | |
|---|---|---|---|---|---|---|
| | | Me- | | | | |
| | Carboxylic Acid/ | Carbazate/ | Alpha Amino | Base/ | DI Water | |
| Example | Amount [g] | Amount [g] | Acid/Amount [g] | Amount [g] | Amount [g] | pH |
| FE1 | citric acid 10.00 | 5.00 | arginine 10.00 | TMAH 30.31 | 441.81 | 7.55 |
| | | | | TEA 2.88 | | |
| FE2 | citric acid 10.08 | 5.22 | arginine 10.00 | TEA 28.18 | 446.52 | 8.02 |
| FE3 | citric acid 10.10 | 5.05 | arginine 10.08 | MEA 6.28 | 468.50 | 8.10 |
| FE4 | citric acid 10.02 | 5.02 | arginine 10.12 | DGA 6.88 | 467.95 | 8.06 |
| FE5 | citric acid 10.00 | 5.00 | arginine 10.00 | TMAH 37.00 | 435.50 | 8.43 |
| | | | | TEA 2.50 | | |
| FE6 | citric acid 10.00 | 5.00 | arginine 10.00 | TEA 19.35 | 455.65 | 7.54 |
| FE7 | citric acid 10.00 | 5.00 | arginine 10.00 | TEA 27.51 | 447.49 | 8.02 |
| FE8 | citric acid 10.00 | 5.00 | arginine 10.00 | TEA 19.35 | 455.65 | 7.56 |
| FE9 | citric acid 20.01 | 10.01 | arginine 20.02 | TEA 38.71 | 411.30 | 7.64 |
| FE10 | citric acid 30.00 | 15.01 | arginine 30.01 | TEA 58.66 | 366.95 | 7.73 |
| FE11 | citric acid 10.00 | 5.00 | arginine 10.00 | TEA 19.35 | 455.65 | 7.56 |
| FE12 | citric acid 10.00 | 5.00 | arginine 10.00 | TMAH 18.00 | 367.00 | 8.97 |
| | | | | TEA 90.00 | | |
| FE13 | citric acid 10.00 | none | arginine 10.00 | TMAH 18.40 | 371.40 | 8.98 |
| | | | | TEA 90.20 | | |
| FE14 | citric acid 10.00 | 5.00 | arginine 10.00 | TEA 19.36 | 455.64 | 7.57 |
| FE15 | citric acid 10.00 | 5.00 | arginine 5.00 | TEA 25.06 | 454.94 | 7.57 |
| FE16 | citric acid 10.00 | 5.00 | arginine 1.24 | TEA 29.16 | 454.60 | 7.58 |
| CFE1 | citric acid 10.00 | 5.02 | none | TMAH 53.55 | 431.70 | 6.51 |
| CFE2 | citric acid 10.00 | 5.00 | none | TMAH 55.58 | 429.60 | 7.02 |
| CFE3 | citric acid 10.00 | 5.00 | none | TMAH 56.52 | 428.46 | 7.60 |
| CFE4 | citric acid 10.00 | 5.02 | none | TMAH 56.88 | 428.10 | 8.08 |
| CFE5 | citric acid 10.00 | 5.00 | none | TMAH 56.78 | 428.22 | 8.02 |
| CFE6 | citric acid 10.00 | 5.00 | arginine 10.00 | TMAH 36.14 | 438.86 | 7.57 |
| CFE7 | none | 5.02 | histidine 10.00 | TMAH 1.40 | 483.58 | 8.06 |
| CFE8 | citric acid 10.05 | 5.00 | arginine 10.05 | TMAH 36.65 | 438.25 | 8.02 |
| CFE9 | citric acid 10.05 | 5.08 | histidine 10.02 | TMAH 57.38 | 417.48 | 8.00 |
| CFE10 | citric acid 10.02 | 5.02 | proline 10.05 | TMAH 56.82 | 418.08 | 8.07 |
| CFE11 | citric acid 10.08 | 5.15 | glycine 10.00 | TMAH 57.45 | 417.32 | 8.01 |
| CFE12 | citric acid 10.02 | 5.05 | leucine 5.02 | TMAH 56.72 | 423.18 | 8.05 |
| CFE13 | citric acid 10.08 | 5.32 | asparagine 5.02 | TMAH 58.05 | 421.52 | 8.01 |
| CFE14 | citric acid 10.05 | 5.02 | tricine 10.15 | TMAH 64.05 | 410.72 | 8.02 |
| CFE15 | citric acid 10.02 | 5.02 | alanine 10.00 | TMAH 57.05 | 417.90 | 8.05 |
| CFE16 | citric acid 10.02 | 5.00 | serine 10.05 | TMAH 58.45 | 416.48 | 8.02 |
| CFE17 | acetic acid 10.00 | 5.02 | arginine 10.05 | TMAH 41.22 | 433.70 | 8.04 |
| CFE18 | lactic acid 11.20 | 5.00 | arginine 10.02 | TMAH 13.50 | 460.28 | 8.04 |
| CFE19 | glycolic acid 14.30 | 5.02 | arginine 10.05 | TMAH 25.02 | 445.60 | 8.04 |
| CFE20 | mandelic acid 10.02 | 5.02 | arginine 10.05 | TMAH 4.20 | 470.70 | 8.02 |
| CFE21 | maleamic acid 10.00 | 5.08 | arginine 10.00 | TMAH 11.32 | 463.60 | 8.01 |
| CFE22 | oxalic acid 10.00 | 5.00 | arginine 10.02 | TMAH 37.72 | 437.25 | 8.06 |
| CFE23 | malonic acid 10.02 | 5.08 | arginine 10.00 | TMAH 50.22 | 424.68 | 8.03 |
| CFE24 | malic acid 10.02 | 5.05 | arginine 10.00 | TMAH 34.45 | 440.52 | 8.02 |
| CFE25 | tartaric acid 10.00 | 5.02 | Arginine 10.00 | TMAH 28.62 | 446.35 | 8.02 |
| CFE26 | citric acid 10.15 | 5.08 | histidine 10.02 | TMAH 50.72 | 424.02 | 7.01 |
| CFE27 | citric acid 10.15 | 5.10 | histidine 10.02 | TMAH 65.75 | 408.98 | 9.01 |
| CFE28 | citric acid 10.55 | 5.00 | arginine 10.00 | TMAH 41.00 | 433.45 | 8.50 |
| CFE29 | citric acid 10.00 | 5.00 | none | TMAH 0.04 | 484.96 | 3.15 |
| CFE30 | citric acid 10.00 | 5.00 | none | TMAH 53.60 | 431.20 | 6.53 |
| CFE32 | citric acid 10.00 | 5.00 | none | TMAH 34.70 | 360.30 | 8.99 |
| | | | | TEA 90.00 | | |
| CFE33 | citric acid 10.00 | none | none | TMAH 34.96 | 364.90 | 8.99 |
| | | | | TEA 90.14 | | |

Notes:
Me-Carbazate is methyl carbazate; Lactic acid is a 90% lactic acid solution; Glycolic acid is a 70% glycolic acid solution; TMAH is a 25% aqueous tetramethylammonium hydroxide solution; TEA is triethanolamine; MEA is monoethanolamine; DGA is diglycolamine.

### Comparative Examples C1-C4

### pH Variations

Aluminum corrosion and cleaning responses were measured on substrates containing isolated and dense vias with exposed TiN/Ti, SiON, SiO₂, and FSG layers. These same substrates also contained an aluminum line stack with the following layers: FSG/TiN/Ti/Al/TiN/Ti. The substrates had been exposed to a via etch and post etch resist ashing process prior to cleaning. Cleaning tests were performed as outlined in General Procedure 2. Substrate chips were immersed for 30 minutes into the cleaning compositions heated to 65° C. Cleaning efficiency was gauged by the amount of post ash residues left on top of isolated and dense via arrays and aluminum corrosion by the severity of line attack or the lack thereof. Results are given in Table 3.

TABLE 3
Cleaning and Corrosion Results for Comparative Formulations at
varying pH

| | | | Cleaning | Corrosion | Overall rating |
|---|---|---|---|---|---|
| Example # | Form. # | pH | (1 to 10) | (1 to 10) | (2-20) |
| C1 | CFE1 | 6.51 | 1 | 9.5 | 10.5 |
| C2 | CFE2 | 7.02 | 3 | 7 | 10 |
| C3 | CFE3 | 7.60 | 4 | 3 | 8 |
| C4 | CFE4 | 8.08 | 9 | 1 | 10 |

Note to cleaning rating: 1 = no residue removed; 10 = all of the residue was removed
Note to Al corrosion rating: 1 = Al line was completely removed; 10 = No visible Al line corrosion
Note to overall rating: Cleaning rating + Corrosion rating (maximum = 20)

Formulations at low pH (7 or less) resulted in an incomplete cleaning response. The pH of the formulation needs to be high to achieve an adequate cleaning result. For the above cleaning formulations a pH of 8 was necessary for cleaning. However the Aluminum corrosion at that pH was severe. Additional corrosion inhibition is necessary.

### Examples 1-5 and Comparative Examples C5-C27

### Aluminum Corrosion Testing

Various materials were screened for their ability to inhibit Al corrosion in cleaning compositions of this disclosure. The substrate tested for aluminum corrosion contained Ti/TiN capped AlCu lines on SiO₂. Sample coupons were treated as described in General Procedure 2 and the aluminum lines were examined for signs of corrosion. All tests were carried out @65° C. with 30 minute immersion times. Results are listed in Table 4.

TABLE 4
Corrosion Screening Results

| | | | | | | Corrosion |
|---|---|---|---|---|---|---|
| Example | Form. | Amino | Carboxylic | | | Rating |
| # | # | Acid | Acid | Base | pH | (1 to 10) |
| C5 | CFE3 | none | citric | TMAH | 7.60 | 2 |
| C6 | CFE5 | none | citric | TMAH | 8.02 | 1 |
| C7 | CFE6 | arginine | citric | TMAH | 7.57 | 9.5 |
| 1 | FE1 | arginine | citric | TMAH/TEA | 7.55 | 10 |
| C8 | CFE7 | histidine | none | TMAH | 8.06 | 2 |
| C9 | CFE8 | arginine | citric | TMAH | 8.02 | 9 |
| C10 | CFE9 | histidine | citric | TMAH | 8.00 | 10 |
| C11 | CFE10 | Proline | citric | TMAH | 8.07 | 2 |
| C12 | CFE11 | Glycine | citric | TMAH | 8.01 | 9 |
| C13 | CFE12 | leucine | citric | TMAH | 8.05 | 4 |
| C14 | CFE13 | asparagine | citric | TMAH | 8.01 | 8 |
| C15 | CFE14 | tricine | citric | TMAH | 8.02 | 7 |
| C16 | CFE15 | alanine | citric | TMAH | 8.05 | 6 |
| C17 | CFE16 | serine | citric | TMAH | 8.02 | 10 |
| C18 | CFE17 | arginine | acetic | TMAH | 8.04 | 3 |
| C19 | CFE18 | arginine | lactic | TMAH | 8.04 | 1 |
| C20 | CFE19 | arginine | glycolic | TMAH | 8.04 | 3 |
| C21 | CFE20 | arginine | mandelic | TMAH | 8.02 | 1 |
| C22 | CFE21 | arginine | maleaminc | TMAH | 8.01 | 4 |
| C23 | CFE22 | arginine | oxalic | TMAH | 8.06 | 4 |
| C24 | CFE23 | arginine | malonic | TMAH | 8.03 | 1 |
| C25 | CFE24 | arginine | malic | TMAH | 8.02 | 9.5 |
| C26 | CFE25 | arginine | tartaric | TMAH | 8.02 | 8 |
| 2 | FE2 | arginine | citric | TEA | 8.02 | 9.5 |
| 3 | FE3 | arginine | citric | MEA | 8.10 | 8 |
| 4 | FE4 | arginine | citric | DGA | 8.06 | 9 |
| C27 | CFE28 | arginine | citric | TMAH | 8.50 | 6 |
| 5 | FE5 | arginine | citric | TMAH/TEA | 8.43 | 5 |

Note to Al corrosion rating: 1 = Al line was completely removed; 10 = No visible Al line corrosion

As can be seen, aluminum corrosion is high if either the carboxylic acid or the amino carboxylic acid is missing from the formulation at a pH high enough to give good cleaning (as determined in Comparative Examples 1-4). The selection of the right combination of amino acid and carboxylic acid also matters. Amino acids containing an additional chelating functional group in addition to the amino acid functionality appear to do better in terms of corrosion inhibition. On the carboxylic acid side only acids with multiple carboxylic acid groups and at least one hydroxyl group, like citric acid, tartaric acid and malic acid exhibited good corrosion inhibition. Alkanolamine and TMAH performed comparably in terms of Al corrosion.

### Examples 6-11 and Comparative Examples C28-C36

### Cleaning and Al Corrosion Response

Aluminum corrosion and cleaning responses were measured on the same type of substrates used in the earlier Comparative Examples 1-4. Cleaning tests were performed as outlined in General Procedure 2. Substrate coupons were immersed into the cleaning compositions heated to 65° C. for times given in Table 5. Cleaning efficiency was gauged by the amount of post ash residues left on top of isolated and dense via arrays and aluminum corrosion by the severity of line attack or the lack thereof. Results are given in Table 5.

TABLE 5
Cleaning and Al Corrosion Results

| | | | | | Process | Clean | Corrosion | Overall |
|---|---|---|---|---|---|---|---|---|
| Example | Form. | Amino | | | Time | Rating | Rating | Rating |
| # | # | Acid | Base | pH | [min] | (1 to 10) | (1 to 10) | (2-20) |
| C28 | CFE3 | none | TMAH | 7.60 | 30 | 4 | 3 | 7 |
| C29 | CFE4 | none | TMAH | 8.08 | 30 | 9 | 1 | 10 |
| C30 | CFE26 | histidine | TMAH | 7.01 | 30 | 2 | 10 | 12 |
| C31 | CFE6 | arginine | TMAH | 7.57 | 30 | 4 | 9.5 | 13.5 |
| 6 | FE1 | arginine | TMAH/TEA | 7.55 | 30 | 4 | 10 | 14 |
| 7 | FE11 | arginine | TEA | 7.54 | 30 | 4 | 10 | 14 |
| 8 | FE7 | arginine | TEA | 8.02 | 30 | 9 | 7 | 16 |
| C32 | CFE9 | histidine | TMAH | 8.00 | 30 | 4 | 7 | 11 |
| C33 | CFE27 | histidine | TMAH | 9.01 | 30 | 9 | 2 | 11 |
| C34 | CFE3 | none | TMAH | 7.60 | 40 | 6 | 2 | 8 |
| C35 | CFE4 | none | TMAH | 8.08 | 40 | 9 | 1 | 10 |
| C36 | CFE6 | arginine | TMAH | 7.57 | 40 | 7.5 | 7 | 14.5 |
| 9 | FE1 | arginine | TMAH/TEA | 7.55 | 40 | 8 | 9.5 | 17.5 |
| 10 | FE6 | arginine | TEA | 7.54 | 40 | 8 | 9.5 | 17.5 |
| 11 | FE7 | arginine | TEA | 8.02 | 40 | 9 | 5 | 14 |

Note to cleaning rating: 1 = no residue removed; 10 = all of the residue was removed
Note to Al corrosion rating: 1 = Al line was completely removed; 10 = No visible Al line corrosion
Note to overall rating: Cleaning rating + Corrosion rating (maximum = 20)

Cleaning compositions with a combination of amino acid and hydroxycarboxylic acid outperformed the Comparative Examples 1-4 (Table 3). Improved cleaning with good Al corrosion control was achieved. The presence of TEA in combination with TMAH or by itself improved both the cleaning capacity and the corrosion resistance. These compositions had surprisingly good cleaning results with excellent corrosion control. Longer immersion times as well as an increased pH of the cleaning composition resulted in improved cleaning performance, while Al corrosion ratings decreased slightly.

### Examples 12-21 and Comparative Examples C37-C39

### Process Variation and Bath Life

When the cleaning composition is used in a batch mode, evaporation of water during the cleaning operation may occur. If this happens the concentration of cleaning components (a) to (d) would increase. To simulate this behavior Formulations FE8, FE9 and FE10 were prepared at different concentrations while the ratio of the components (except for water) remained the same. Aluminum corrosion and cleaning responses were measured on the same type of substrates used in the earlier Comparative Examples 1-4. Cleaning tests were performed as outlined in General Procedure 2. Cleaning efficiency was gauged by the amount of post ash residues left on top of isolated and dense via arrays and aluminum corrosion by the severity of line attack or the lack thereof. Results are given in Table 6.

TABLE 6
Cleaning and Al Corrosion Results - Process and Concentration Variations

| | | | | | Process | | | |
|---|---|---|---|---|---|---|---|---|
| Example | Form. | | | Process | Time | Cleaning | Corrosion | Overall rating |
| # | # | pH | Conc. | Temp [C.] | [min] | (1 to 10) | (1 to 10) | (2-20) |
| 12 | FE8 | 7.56 | 1X | 60 | 30 | 1 | 10 | 11 |
| 13 | FE8 | 7.56 | 1X | 60 | 40 | 2 | 10 | 12 |
| 14 | FE8 | 7.56 | 1X | 65 | 30 | 2 | 10 | 12 |
| 15 | FE8 | 7.56 | 1X | 65 | 40 | 6 | 9 | 15 |
| 16 | FE8 | 7.56 | 1X | 70 | 30 | 6 | 9.5 | 15.5 |
| 17 | FE8 | 7.56 | 1X | 70 | 40 | 9 | 7 | 16 |
| 18 | FE9 | 7.64 | 2X | 65 | 30 | 6 | 10 | 16 |
| 19 | FE9 | 7.64 | 2X | 65 | 40 | 7.5 | 10 | 17.5 |
| 20 | FE10 | 7.73 | 3X | 65 | 30 | 4 | 10 | 14 |
| 21 | FE10 | 7.73 | 3X | 65 | 40 | 4 | 10 | 14 |
| C37 | CFE29 | 3.15 | | 65 | 30 | 1 | 10 | 11 |
| C38 | CFE30 | 6.53 | | 65 | 40 | 1 | 10 | 11 |
| C39 | CFE29 | 3.15 | | 65 | 30 | 2 | 8.5 | 10.5 |

Note to cleaning rating: 1 = no residue removed; 10 = all of the residue was removed
Note to Al corrosion rating: 1 = Al line was completely removed; 10 = No visible Al line corrosion
Note to overall rating: Cleaning rating + Corrosion rating

Longer processing times and higher bath temperatures resulted in better cleaning, but corrosion performance dropped off somewhat. This illustrates the need for process optimization to balance corrosion and cleaning performance. Aluminum corrosion was either not affected or slightly improved by the increase in cleaner concentration. Further process optimization will need to be done for a particular substrate to optimize performance.

### Comparative Examples C40-C41 and Examples 22-23

### Component Evaluation

Various components in cleaning compositions of this disclosure were evaluated for their ability to inhibit Al corrosion. To evaluate the function of components Formulations FE12, FE13, CFE31, and CFE32 were prepared. The substrate tested for aluminum corrosion is the same type of substrates used in the earlier Comparative Examples 1-4. Sample coupons were treated as described in General Procedure 2 and the aluminum lines were examined for signs of corrosion. All tests were carried out @70° C. with 15 minute immersion times. Results are listed in Table 7.

TABLE 7
Al Corrosion Results - Component Evaluations

| | | | | Hydrazino | | | Corrosion |
|---|---|---|---|---|---|---|---|
| Example | Form. | Carboxylic | | Carboxylic | | | Rating |
| # | # | Acid | Amino Acid | Acid | Base | pH | (1 to 10) |
| 22 | FE12 | citric | arginine | Me-carbazate | TEA/TMAH | 8.97 | 5.5 |
| 23 | FE13 | citric | arginine | none | TEA/TMAH | 8.98 | 5 |
| C40 | CFE31 | citric | none | Me-carbazate | TEA/TMAH | 8.99 | 2.5 |
| C41 | CFE32 | citric | none | none | TEA/TMAH | 8.99 | 1 |

Note to Al corrosion rating: 1 = Al line was completely removed; 10 = No visible Al line corrosion

As can be seen, aluminum corrosion is high if the amino acid is missing from the formulation at a pH high enough to give good cleaning (as determined in Comparative Examples 1-4).

### Examples 24-26

### Amino Acid Concentration Minimization

Formulations FE14, FE15, and FE16 were prepared to explore the minimum amount of amino acid required in cleaning compositions of this disclosure to maintain cleaning and corrosion performance. Aluminum corrosion and cleaning responses were measured on the same type of substrates used in the earlier Comparative Examples 1-4. Cleaning tests were performed as outlined in General Procedure 2. Substrate coupons were immersed into the cleaning compositions heated to 70° C. with 30 minute immersion times. Cleaning efficiency was gauged by the amount of post ash residues left on top of isolated and dense via arrays and aluminum corrosion by the severity of line attack or the lack thereof. Results are given in Table 8.

TABLE 8
Cleaning and Al Corrosion Results - Amino Acid Concentration Minimization

| Example | Form. | | | Cleaning | Corrosion | Overall rating |
|---|---|---|---|---|---|---|
| # | # | Amino Acid | pH | (1 to 10) | (1 to 10) | (2-20) |
| 24 | FE14 | Arginine 1X | 7.57 | 6 | 9.5 | 15.5 |
| 25 | FE15 | Arginine 0.5X | 7.57 | 6 | 8 | 14 |
| 26 | FE16 | Arginine 0.125X | 7.58 | 5 | 6 | 11 |

Note to cleaning rating: 1 = no residue removed; 10 = all of the residue was removed
Note to Al corrosion rating: 1 = Al line was completely removed; 10 = No visible Al line corrosion
Note to overall rating: Cleaning rating + Corrosion rating

Decrease of the amino acid concentration in cleaning compositions of this disclosure resulted in increase of Al corrosion. Cleaning performance was either slightly reduced or not affected by the decrease in the amino acid concentration

While the present disclosure has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. A composition, comprising:
(a) at least one alpha amino carboxylic acid containing at least one additional functional group capable of chelating metals with the proviso that the at least one alpha amino carboxylic acid does not contain an additional carboxyl group;
(b) at least one hydroxycarboxylic acid containing at least two carboxyl groups and at least one hydroxyl group, wherein the at least one hydroxycarboxylic acid does not contain an amino group alpha to a carboxylic acid group;
(c) optionally, at least one hydrazinocarboxylic acid ester;
(d) at least one alkanolamine; and
(e) water;
wherein the pH of the composition is between about 6 and about 10.

2. The composition of claim 1, wherein the at least one alpha amino carboxylic acid is at least one compound of Structure (1): 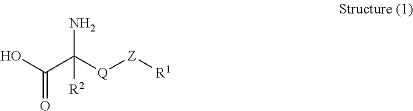
wherein Q is an unsubstituted branched or linear C₁-C₅ alkylene or ˜CH₂—(CH₂)ₙ—O˜, n being an integer from 0 to 5; Z is ˜NR³˜ or a divalent bond, R³ being a hydrogen atom or a C₁-C₄ alkyl group; R¹ is an imidazolyl, H₂N—C(═NR⁴)˜, NH₂NH—C(═NR⁵)˜, amino, amido, hydrazino, hydroxyl, or thiol group, or a C₁-C₅ alkyl group substituted with at least one functional group selected from the group consisting of imidazolyl, guanido, amino, amido, hydrazino, hydroxyl, and thiol group; R⁴ and R⁵ independently being a hydrogen atom or a C₁-C₄ alkyl group; and R² is a hydrogen atom or a C₁-C₄ alkyl group.

3. The composition of claim 1, wherein the at least one alpha amino carboxylic acid is selected from the group consisting of creatine, guanidineacetic acid, and compounds of Structure (1b) 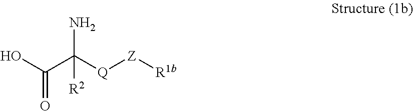
wherein Q is an unsubstituted branched or linear C₁-C₅ alkylene or ˜CH₂—(CH₂)ₙ—O˜; n being an integer from 0 to 5; Z is ˜NR³˜ or a divalent bond, R³ being a hydrogen atom or a C₁-C₄ alkyl group; R^{1b} is an imidazolyl, H₂N—C(═NR⁴)˜, or NH₂NH—C(═NR⁵)˜ group, or a C₁-C₅ alkyl group substituted with at least one functional group selected from the group consisting of imidazolyl and guanido, R⁴ and R⁵ independently being a hydrogen atom or a C₁-C₄ alkyl group; and R² is a hydrogen atom or a C₁-C₄ alkyl group.

4. The composition of claim 1, wherein the at least one hydroxycarboxylic acid is selected from the group consisting of hydroxycarboxylic acids with two carboxyl groups and two hydroxyl groups, hydroxycarboxylic acids with two carboxyl groups and three hydroxyl groups, hydroxycarboxylic acids with three or more carboxyl groups and one hydroxyl group, and hydroxycarboxylic acids with three or more carboxyl groups and two or more hydroxyl groups.

5. The composition of claim 1, wherein the at least one hydroxycarboxylic acid is a hydroxycarboxylic acid with three or more carboxyl groups and one hydroxyl group.

6. The composition of claim 1, wherein the composition comprises at least one hydrazinocarboxylic acid ester of Structure (2):
R¹⁰—O—CO—NH—NH₂ Structure (2)
wherein R¹⁰ is a substituted or unsubstituted, straight-chain or branched C₁-C₁₀ alkyl group, an optionally substituted C₃-C₁₀ cycloalkyl group, or an optionally substituted C₆-C₁₄ aryl group.

7. The composition of claim 6, wherein the at least one hydrazinocarboxylic acid ester is selected from the group consisting of methyl carbazate, ethyl carbazate, t-butyl carbazate, and benzyl carbazate.

8. The composition of claim 1, wherein the at least one alkanolamine is an alkanolamine of Structure (3): 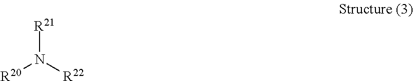
wherein R²⁰, R²¹, and R²² are independently a hydrogen atom, or a linear, branched or cyclic alkyl optionally substituted by one or more hydroxyl groups and optionally containing an oxygen atom in its chain; or any two of the R²⁰, R²¹, and R²² groups, together with the nitrogen atom to which they are attached, form a C₃-C₁₄ cyclic structure; with the proviso that at least one of R²⁰, R²¹, and R²² contains at least one hydroxyl group.

9. The composition of claim 8, wherein the at least one alkanolamine is a tertiary alkanolamine.

10. The composition of claim 1, wherein the pH of the composition is between about 6.5 and about 9.5.

11. The composition of claim 1, wherein the pH of the composition is between about 7 and about 9.

12. The composition of claim 1, wherein
the at least one alpha amino carboxylic acid is selected from the group consisting of creatine, guanidineacetic acid, and compounds of Structure (1b): 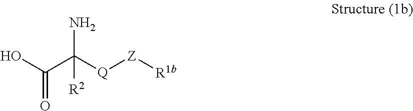
wherein Q is an unsubstituted branched or linear C₁-C₅ alkylene, or ˜CH₂—(CH₂)ₙ—O˜, n being an integer from 0 to 5; Z is ˜NR³˜ or a divalent bond; R³ is a hydrogen atom or a C₁-C₄ alkyl group; R^{1b} is an imidazolyl, H₂N—C(═NR⁴)˜, or NH₂NH—C(═NR⁵)˜ group, or a C₁-C₅ alkyl group substituted with at least one functional group selected from the group consisting of imidazolyl or guanido, R⁴ and R⁵ independently being a hydrogen atom or a C₁-C₄ alkyl group; and R² is a hydrogen atom or a C₁-C₄ alkyl group;
the at least one hydroxycarboxylic acid is a hydroxycarboxylic acid with three or more carboxyl groups and one hydroxyl group;
the optional at least one hydrazinocarboxylic acid ester is selected from the group consisting of methyl carbazate, ethyl carbazate, t-butyl carbazate, and benzyl carbazate;
the at least one alkanolamine is a tertiary alkanolamine of Structure (3): 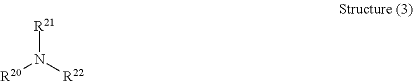
wherein R²⁰, R²¹, and R²² are independently a linear, branched or cyclic alkyl optionally substituted by one or more hydroxyl group and optionally containing an oxygen atom in its chain; or any two of the R²⁰, R²¹, and R²² groups, together with the nitrogen atom to which they are attached, form a C₃-C₁₄ cyclic structure; with the proviso that at least one of R²⁰, R²¹, and R²² contains at least one hydroxyl group; and
the pH of the composition is between about 7 and about 9.

13. The composition of claim 1, wherein the composition further comprises a pH adjusting agent other than an alkanolamine.

14. The composition of claim 13, wherein the pH adjusting agent is tetramethylammonium hydroxide.

15. The method of claim 1, wherein the composition is free of components containing fluorides, abrasives, or oxidizers.

16. A method of cleaning residues from a semiconductor substrate, comprising:
(A) contacting a semiconductor substrate with a composition comprising:
(a) at least one alpha amino carboxylic acid containing at least one additional functional group capable of chelating metals with the proviso that the at least one alpha amino carboxylic acid does not contain an additional carboxyl group;
(b) at least one hydroxycarboxylic acid containing at least two carboxyl groups and at least one hydroxyl group, wherein the at least one hydroxycarboxylic acid does not contain an amino group alpha to a carboxylic acid group;
(c) optionally, at least one hydrazinocarboxylic acid ester;
(d) at least one alkanolamine; and
(e) water;
wherein the pH of the composition is between about 6 and about 10;
(B) rinsing the semiconductor substrate with a solvent; and
(C) optionally, drying the semiconductor substrate to remove the solvent.

17. The method of claim 16, wherein contacting a semiconductor substrate with a composition comprises immersing the semiconductor substrate into the cleaning composition, spraying the composition onto the semiconductor substrate, streaming the composition onto the semiconductor substrate, or any combination thereof.

18. The method of claim 16, wherein the solvent comprises deionized water, methanol, ethanol, isopropyl alcohol, N-methylpyrrolidinone, gamma-butyrolactone, dimethyl sulfoxide, ethyl lactate, propylene glycol monomethyl ether acetate, or a combination thereof.

19. The method of claim 16, wherein the optional drying the semiconductor substrate comprises spin drying the semiconductor substrate, flowing a dry gas across the semiconductor substrate, heating the semiconductor substrate, Maragoni drying the semiconductor substrate, rotagoni drying the semiconductor substrate, IPA drying the semiconductor substrate, or a combination thereof.

20. A method of manufacturing an integrated circuit device, comprising:
(A) contacting a semiconductor substrate with a composition comprising:
(a) at least one alpha amino carboxylic acid containing at least one additional functional group capable of chelating metals with the proviso that the at least one alpha amino carboxylic acid does not contain an additional carboxyl group;
(b) at least one hydroxycarboxylic acid containing at least two carboxyl groups and at least one hydroxyl group, wherein the at least one hydroxycarboxylic acid does not contain an amino group alpha to a carboxylic acid group;
(c) optionally, at least one hydrazinocarboxylic acid ester;
(d) at least one alkanolamine, and
(e) water;
wherein the pH of the composition is between about 6 and about 10;
(B) rinsing the semiconductor substrate with a solvent; and
(C) optionally, drying the semiconductor substrate to remove the solvent
(D) processing the semiconductor substrate to form an integrated circuit device.
